(19) United States
(12) Patent Application Publication
(10) Pub. No.: US 2008/0218360 A1
(43) Pub. Date: Sep. 11, 2008

(54) TRANSMISSION APPARATUS, TRANSMISSION METHOD AND RECORDING MEDIUM WITH RECORDED TRANSMISSION PROGRAM

(75) Inventors: Koji Nekoda, Fukuoka (JP); Kenichi Ohyama, Fukuoka (JP); Atsunori Machida, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/033,396

(22) Filed: Feb. 19, 2008

(30) Foreign Application Priority Data
Feb. 20, 2007 (JP) 2007-039929

(51) Int. Cl. G08B 17/00

(52) U.S. Cl. 340/584

(57) ABSTRACT

A transmission apparatus transmitting/receiving data to and from other transmission apparatuses through a network includes a temperature rise detector detecting a temperature rise of the transmission apparatus and a communication controller restricting transmission from the other transmission apparatuses to the transmission apparatus when the temperature rise of the transmission apparatus is detected.

### CROSS-REFERENCE TO RELATED APPLICATION(S)

This application is related to and claims priority to Japanese patent application no. 2007-39929 filed on Feb. 20, 2007, in the Japan Patent Office, and incorporated by reference herein.

### BACKGROUND

1. Field

The embodiments relate to a transmission apparatus, a transmission method and a recording medium in which a transmission program is recorded.

2. Description of the Related Art

Conventionally, in a transmission apparatus for relaying data communication to configure a communication network, for example, a router, a gateway, an Ether switch, etc., it is general that communication with other transmission apparatuses is controlled.

For example, Japanese Patent Laid-Open No. 2006-245992 discloses a transmission apparatus for controlling communication depending on the amount of information remaining in a buffer memory. Specifically, the device of Japanese Patent Lain-Open No. 2006-245992 monitors the buffer memory to control communication using the information of the amount of data remaining in the buffer memory and the time when the data are stored in the buffer memory. For example, when the amount of data remaining in the buffer memory is large or when a delay occurs in the transfer of data, communication is controlled so as to increase the transfer rate from the concerned transmission apparatus so that the data remaining in the buffer memory can be quickly transferred.

### SUMMARY

According to an aspect of an embodiment, an apparatus transmitting and/or receiving data to and from other transmission apparatuses through a network includes a temperature rise detection part detecting the temperature rise of the transmission apparatus; and a communication control part performing control to restrict the sending from the other transmission apparatuses to the transmission apparatus when the temperature rise of the transmission apparatus is detected by the temperature rise detection part.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a network including a transmission apparatus;

FIG. 2 illustrates the outline and features of the transmission apparatus;

FIG. 3 illustrates the outline and features of a transmission apparatus relating to an embodiment 1;

FIG. 4 is a block diagram to show the configuration of the transmission apparatus relating to the embodiment 1;

FIG. 5 is a flowchart to show the flow of the processing by the transmission apparatus relating to the embodiment 1;

FIG. 6 is a sequence to show an example of transmission processing by the transmission apparatus relating to the embodiment 1;

FIG. 7 illustrates the outline and features of a transmission apparatus relating to an embodiment 2;

FIG. 8 is a flowchart to show the processing flow by the transmission apparatus relating to the embodiment 2;

FIG. 9 is a sequence to show an example of transmission processing by the transmission apparatus relating to the embodiment 2;

FIG. 10 illustrates the outline and features of a transmission apparatus relating to an embodiment 3;

FIG. 11 is a flowchart to show the processing flow by the transmission apparatus relating to the embodiment 3;

FIG. 12 is a sequence to show an example of transmission processing by the transmission apparatus relating to the embodiment 3;

FIG. 13 illustrates the outline and features of a transmission apparatus relating to an embodiment 4;

FIG. 14 is a flowchart to show the processing flow by the transmission apparatus relating to the embodiment 4;

FIG. 15 is a sequence to show an example of transmission processing by the transmission apparatus relating to the embodiment 4; and

FIG. 16 shows a computer which executes a transmission program.

### DETAILED DESCRIPTION OF THE EMBODIMENTS

Hereinafter, referring to the appended drawings, embodiments of a transmission apparatus, a transmission method and a transmission program will be described in detail. Moreover, a transmission apparatus (for example, a router, a gateway, and an Ether switch) for relaying data communication to constitute a communication network will be described below. Furthermore, after describing the network including the transmission apparatus, and the outline and features thereof, embodiments 1 to 5 will be described in more detail.

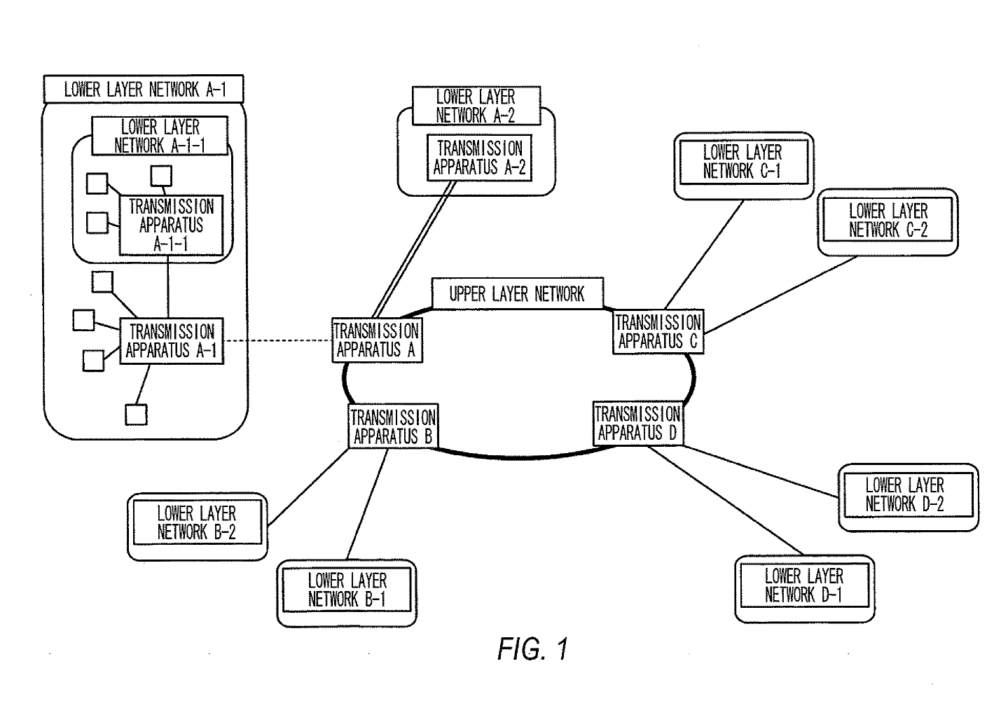

First, a network including a transmission apparatus will be described using FIG. 1. FIG. 1 illustrates a network including a transmission apparatus. As shown in the figure, a transmission apparatus is connected with other transmission apparatuses via a communication interface to constitute a communication network. For example, in the example of FIG. 1, transmission apparatuses A, B, C and D constitute an upper layer network via a communication interface (thick line) for performing optical communication such as the Fiber Channel. Further, a communication network is constructed by the connection through a communication interface (dashed line) in which the transmission apparatus A performs a half-duplex communication scheme such as 10base2 with a transmission apparatus A-1 in a lower layer network A-1, or through a communication interface (doublet) in which the transmission apparatus A performs a full-duplex communication scheme such as 100base-T with a transmission apparatus A-2 in a lower layer network A-2.

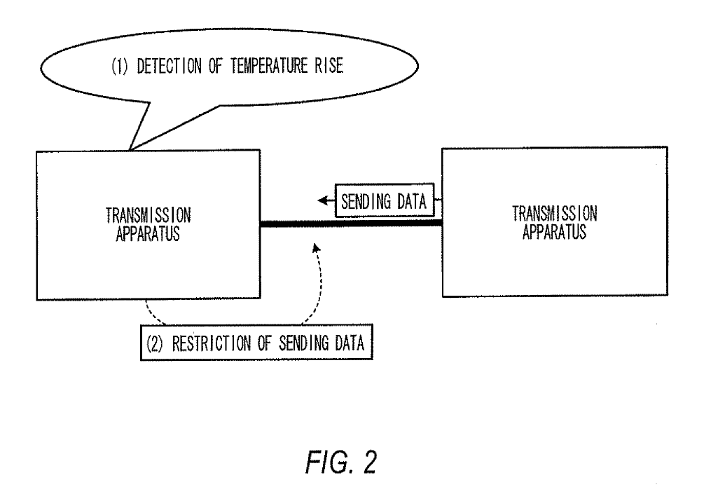

Next, referring to FIG. 2, the outline and features of a transmission apparatus will be described. FIG. 2 illustrates the outline and features of a transmission apparatus. As shown in the figure, the transmission apparatus generally transmits data to and from other transmission apparatuses through a network. Further, a characteristic feature of the transmission apparatus is to prevent failures or malfunctions of the communication device in the transmission apparatus associated with the temperature rise of the transmission apparatus.

That is, the transmission apparatus detects the temperature rise of the transmission apparatus and performs control to restrict the sending from other transmission apparatuses when a temperature rise of the transmission apparatus is detected. Specifically, as shown in FIG. 2, when a temperature rise of the transmission apparatus is detected (see (1) of FIG. 2) (for example when the temperature of the communication device rises), control is performed such that the sending of data from other transmission apparatuses is restricted (see (2) of FIG. 2).

### Embodiment 1

In an embodiment 1 described below, the outline and features of a transmission apparatus relating to the embodiment 1, the configuration of each device constituting the transmission apparatus, the processing by the transmission apparatus, the transmission processing by the transmission apparatus, and the effect of the transmission apparatus will be described, and finally various variations to the embodiment 1 will be further described.

Outline and Features of a Transmission Apparatus Relating to the Embodiment 1 is as Follows:

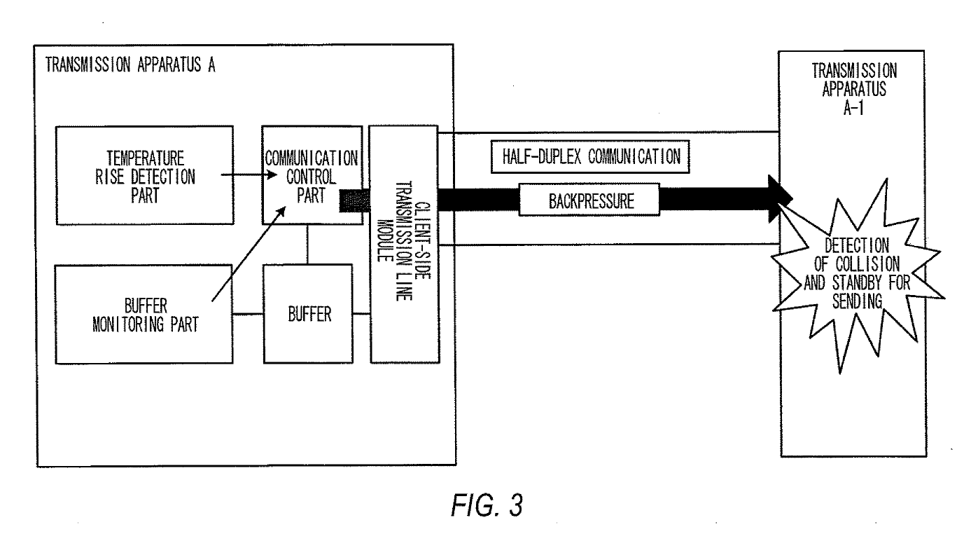

First, referring to FIG. 3, the outline and features of the transmission apparatus relating to the embodiment 1 will be described. FIG. 3 illustrates the outline and features of the transmission apparatus relating to the embodiment 1.

As shown in the figure, the transmission apparatus relating to the embodiment 1 transmits data to and from other transmission apparatuses through a half-duplex communication scheme to control the communication. Specifically describing by way of example, the transmission apparatus is connected by a communication interface (for example, 10base2) (dashed line) which operates through a half-duplex communication scheme as with the transmission apparatus A and the transmission apparatus A-1 in FIG. 1, and controls the transmission through a CSMA/CD (Carrier Sense Multiple Access with Collision Detection) scheme.

More precisely, since when two transmission apparatuses send data at the same time in a half-duplex communication scheme, a collision of data occurs at a communication interface thereby causing a communication failure, the transmission apparatus relating to the embodiment 1 confirms the detection of a collision when sending data to another transmission apparatus, and sends data only when it is determined that there is no detection, thereby performing either-way communication. Moreover, for example when the amount of data information remaining in a buffer memory is large, or when a delay in data transfer occurs, the transmission apparatus relating to the embodiment 1 sends backpressure, which is a signal for stopping the half-duplex communication scheme, from the communication control part to another transmission apparatus (for example, the transmission apparatus A-1) via a client-side transmission line module so that the data remaining in the buffer memory can be quickly transferred. Thus, the transmission apparatus relating to the embodiment 1 makes another transmission apparatus detect a collision when it sends data so that the sending of data from the other transmission apparatus (for example, the transmission apparatus A-1) to the concerned transmission apparatus (for example, the transmission apparatus A) is put on standby.

As described in the above outline, it is a principal feature of the transmission apparatus relating to the embodiment 1 to prevent failures and malfunctions of the communication device in the transmission apparatus associated with the temperature rise of the transmission apparatus by use of the above described backpressure. Specifically, as shown in FIG. 3, when a temperature rise is detected at the temperature rise detection part, a transmission apparatus relating to the embodiment 1 (for example, the transmission apparatus A) sends backpressure, which is a signal for stopping the half-duplex communication scheme, from the communication control part to another transmission apparatus (for example, the transmission apparatus A-1) via the client-side transmission line module. Then, the transmission apparatus relating to the embodiment 1 makes another transmission apparatus detect a collision when it sends data so that the sending of data from the other transmission apparatus (the transmission apparatus A-1) to the concerned transmission apparatus (the transmission apparatus A) is put on standby. Consequently, the transmission apparatus relating to the embodiment 1 can prevent failures and malfunctions of the communication device in the transmission apparatus associated with the temperature rise of the transmission apparatus by use of the above described backpressure.

Configuration of Transmission Apparatus Relating to Embodiment 1:

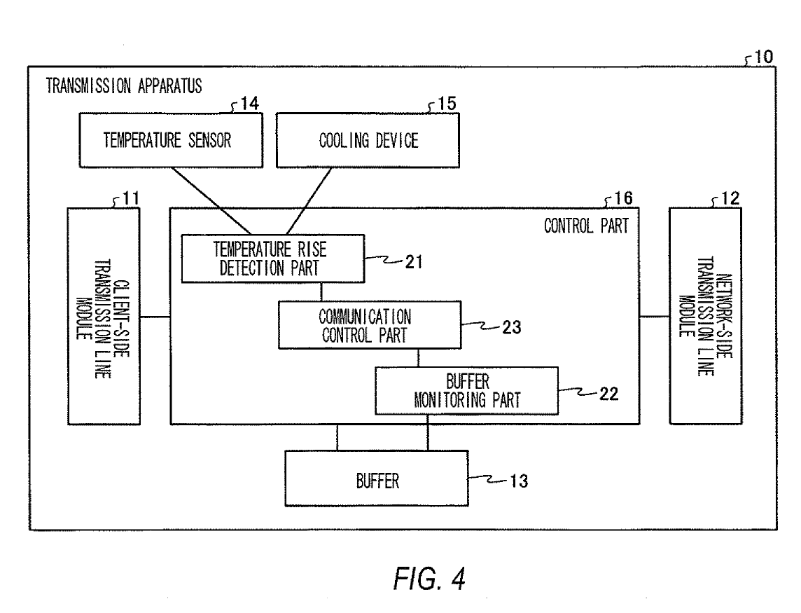

Next, referring to FIG. 4, the configuration of the transmission apparatus relating to the embodiment 1 will be described. FIG. 4 is a block diagram to show the configuration of the transmission apparatus relating to the embodiment 1. As shown in the figure, the transmission apparatus 10 includes a client-side transmission line module 11, a network-side transmission line module 12, a buffer 13, a temperature sensor 14, a cooling device 15, and a control part 16.

In this configuration, the client-side transmission line module 11 controls the communication with the transmission apparatuses connected to the client side, and the network-side transmission line module 12 controls the communication with the transmission apparatuses connected to the network side. Specifically, the client-side transmission line module 11 and the network-side transmission line module 12 are made up of a single or plurality of receiver ports and transfer ports, and the client-side transmission line module 11 sends/receives information to/from the transmission apparatus connected to the client side to transmit it to the control part 16. For example, in the example shown in FIG. 1, the transmission apparatus A sends/receives information to/from the transmission apparatus A-1. The network-side transmission line module 12 sends/receives information to/from the transmission apparatuses connected to the network side and transmits it to the control part 16. For example, in the example shown in FIG. 1, the transmission apparatus A sends/receives information to/from the transmission apparatus B and transmits it to the control part 16.

The buffer 13 is a memory which is temporally used to perform efficient data processing, and specifically the buffer 13 temporally stores information received from other transmission apparatuses.

The temperature sensor 14, which measures temperature, is equivalent to, for example, a platinum thermo resistance sensor or a radiation thermometer. Specifically, the temperature sensor 14 measures the temperature of a communication device (for example, a memory and/or a CPU, and/or other components) in the transmission apparatus (for example, the temperature within the communication device, the temperatures outside the communication device, and/or temperature of inside and/or outside of the communication device, or any combinations thereof.

The cooling device 15, which cools an object, is equivalent to, for example, a cooling fan and/or an air heat exchange cooling device. Specifically, the cooling device 15 cools, for example, the communication device in the transmission apparatus.

The control part 16 includes an internal memory for storing a program and control data for specifying various processing procedures, and executes various processing. The control part 16 includes a temperature rise detection part 21, a buffer monitoring part 22, and a communication control part 23 as what relates closely to the present feature.

Specifically, the control part 16 stores information received from another transmission apparatus via the client-side transmission line module 11 or the network-side transmission line module 12 in the buffer 13, and determines the forwarding transmission apparatus and the transmission condition to send the information stored in the buffer 13 to the forwarding transmission apparatus based on the transmission condition via the client-side transmission line module 11 or the network-side transmission line module 12.

To give a specific example, in FIG. 1, the control part 16 stores the information received from the transmission apparatus A-1 via the client-side transmission line module 11 in the buffer 13 when the transmission apparatus A transmits information received from the transmission apparatus A-1, which is a transmission apparatus on the client side, to the transmission apparatus B, which is a transmission apparatus on the network side. Then, upon determining that the forwarding transmission apparatus is the transmission apparatus B, and also determining a transfer condition, for example, “that the communication interface is a fiber channel,” the control part 16 transmits the information stored in the buffer 13 to the transmission apparatus B via the network-side transmission line module 11 based on the determined transmission condition.

The temperature rise detection part 21 detects the temperature rise of the communication device. Specifically, the temperature rise detection part 21 monitors the temperature sensor 14 and the cooling device 15 and, upon detecting a temperature rise of the communication device, sends a signal for restricting communication to the communication control part 23 depending on the detected condition.

To give a specific example, the temperature rise detection part 21 monitors the temperature sensor 14 and, when the measured temperature of the communication device rises to a predetermined temperature (specifically, a temperature at which failures and malfunctions of the communication device are likely to be induced, for example, 50 degrees C.) sends a signal for restricting communication to the communication control part 23. Further, the temperature rise detection part 21 monitors the cooling device 15 and, upon detection of an abnormal condition in the operation of the cooling device such as failures and malfunctions, sends a signal for restricting communication to the communication control part 23.

The buffer monitoring part 22 monitors the information on the amount of data remaining in the buffer 13 and the time when the data is stored in the buffer 13. Specifically, the buffer monitoring part 22 monitors the information on the amount of data remaining in the buffer 13 and the time when the data is stored in the buffer 13 and sends a signal for restricting communication to the communication control part 23 depending on the state of the buffer 13. To give a specific example, the buffer monitoring part 22 sends a signal for restricting communication to the communication control part 23 when the amount of data remaining in the buffer 13 is large, or when a delay occurs in data transfer.

When the temperature rise of the transmission apparatus is detected, the communication control part 23 sends backpressure to another transmission apparatuses so that sending from the other transmission apparatuses is restricted. Specifically, upon receiving a signal for restricting communication from the temperature rise detection part 21 and/or the buffer monitoring part 22, the communication control part 23 successively sends backpressure which is a signal for stopping a half-duplex communication scheme to other transmission apparatuses.

To give a specific example, in the transmission apparatus A in FIG. 1, the communication control part 23 receives a signal for restricting communication from the temperature rise detection part 21 detecting a temperature rise and/or from the buffer monitoring part 22 and starts successively sending backpressure to the transmission apparatus A-1, which is a transmission apparatus connected though a half duplex communication scheme, to stop sending information from the transmission apparatus A-1 to the transmission apparatus A. And when a situation in which the temperature rise detection part 21 and the buffer monitoring part 22 send the signal for restricting communication to the communication control part 23 is avoided (for example, when the communication device is cooled in the case in which the temperature of the communication device has risen; when the cooling device is repaired in the case in which the cooling device has been in failure; when the amount of data remaining in the buffer is reduced in the case in which the amount of data remaining in the buffer has been large; and so on), the sending of backpressure to the transmission apparatus A-1 is stopped and the sending of information from the transmission apparatus A-1 to the transmission apparatus A is started.

Processing by Transmission Apparatus Relating to Embodiment 1:

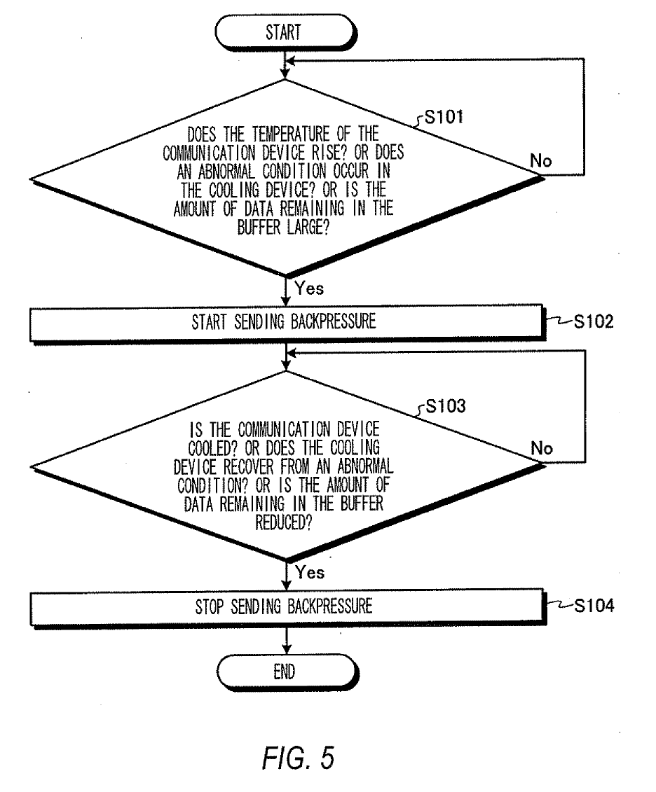

Next, referring to FIG. 5, the transmission apparatus relating to the embodiment 1 will be described. FIG. 5 is a flowchart to show the flow of the processing by the transmission apparatus relating to the embodiment 1.

As shown in FIG. 5, when the temperature rise of the communication device in the transmission apparatus 10 is detected, or when an abnormal condition occurs in the operation of the cooling device, or when the amount of data remaining in the buffer is large, or any combinations thereof (Yes S101), the communication control part 23 starts sending backpressure to other transmission apparatuses (S102). That is, upon receiving a signal for restricting communication from the temperature rise detection part 21 and/or the buffer monitoring part 22, the communication control part 23 starts sending backpressure.

Then, when the communication device is cooled, when the cooling device is recovered from an abnormal condition, or when the amount of data remaining in the buffer is reduced; that is, when the communication device is cooled in the case in which the temperature of the communication device has risen, when the cooling device is repaired in the case in which the cooling device has been in failure, or when the amount of data remaining in the buffer is reduced in the case in which the amount of data remaining in the buffer has been large, or any combinations thereof (Yes at S103), the communication control part 23 stops sending backpressure to other transmission apparatuses (S104) and the transmission apparatus 10 ends the above described processing and returns to a detection state again (S101). That is, when the signal for restricting communication from the temperature rise detection part 21 and/or the buffer monitoring part 22 becomes absent, the communication control part 23 stops sending backpressure, and the transmission apparatus 10 restarts the monitoring of the temperature rise of the communication device, the operation of the cooling device, or the state of the buffer, or any combinations thereof.

Example of Transmission Processing by Transmission Apparatus Relating to Embodiment 1:

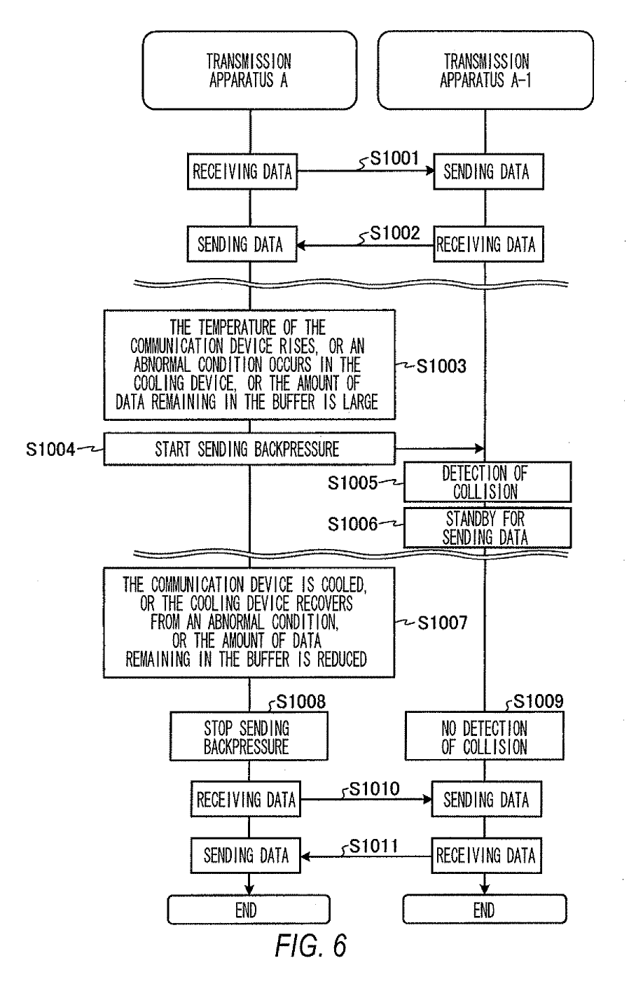

Next, referring to FIG. 6, an example of the transmission processing by the transmission apparatus relating to the embodiment I will be described. FIG. 6 is a sequence to show an example of transmission processing by the transmission apparatus relating to the embodiment 1. Hereinafter, description will be made on a case as an example in which the transmission apparatus A, which is a transmission apparatus relating to the embodiment 1, restricts the sending from the transmission apparatus A-1, which are connected by a communication interface for performing a half duplex communication scheme as in the case of the transmission apparatus A and the transmission apparatus A-1 shown in FIG. 1.

As shown in FIG. 6, the transmission apparatus A performs the transmission with the transmission apparatus A-1 through a CSMA/CD scheme. That is, when the temperature rise of the communication device is not detected in the transmission apparatus A, and when no abnormal condition occurred in the operation of the cooling device, and when the amount of data remaining in the buffer is small, the transmission apparatus A sends data to the transmission apparatus A-1 without detecting a collision when sending data to the transmission apparatus A-1 (S1001). At the same time, the transmission apparatus A-1 also sends data to the transmission apparatus A without detecting a collision when sending data to the transmission apparatus A thereby performing either-way communication (S1002).

Here, if a case occurs where the temperature rise in the communication device is detected in the transmission apparatus A, where an abnormal condition occurs in the operation of the cooling device, or where the amount of data remaining in the buffer is large (S1003), the communication control part 23 in the transmission apparatus A starts sending backpressure to the transmission apparatus A-1 (S1004). Consequently, the transmission apparatus A-1 detects a collision when sending data to the transmission apparatus A (S1005) and stands by for sending data to the transmission apparatus A (S1006).

Thereafter, for example, when the communication device is cooled in the case in which the temperature of the communication device has risen, when the cooling device is repaired in the case in which the cooling device has been in failure, or when the amount of data remaining in the buffer is reduced in the case in which the amount of data remaining in the buffer has been large (S1007), the communication control part 23 in the transmission apparatus A stops sending backpressure to the transmission apparatus A-1 (S1008). Consequently, the transmission apparatus A-1 will no more detect a collision when sending data to the transmission apparatus A (S1009), and again performs transmission with the transmission apparatus A through a CSMA/CD scheme (S1010 and S1011).

### Effects of Embodiment 1

Thus, according to the embodiment 1, since the temperature rise of the transmission apparatus is detected and control is performed such that the sending from other transmission apparatuses is restricted when the temperature rise of the transmission apparatus is detected, it is possible to prevent the temperature rise of the communication device by restricting the sending from other transmission apparatuses to reduce the amount of data to be processed by the communication device, thereby preventing failures and malfunctions of the communication device.

Moreover, according to the embodiment 1, since the temperature of the transmission apparatus is measured to detect a temperature rise, it is possible to prevent the temperature rise of the communication device by restricting the sending from other transmission apparatuses depending on the temperature of the transmission apparatus to reduce the amount of data to be processed by the communication device, thereby preventing failures and malfunctions of the communication device.

Further, according to the embodiment 1, since the temperature rise is detected by monitoring the operation of the cooling device for cooling the transmission apparatus, it is possible to prevent the temperature rise of the communication device by restricting the sending from other transmission apparatuses depending on the temperature rise of the communication device caused by the abnormal conditions in the operation of the cooling device to reduce the amount of data to be processed by the communication device, thereby preventing failures and malfunctions of the communication device.

Furthermore, according to the embodiment 1, since it is controlled such that the sending from other transmission apparatuses is restricted by sending backpressure to other transmission apparatuses, as the result of putting the sending through a half-duplex communication scheme from other transmission apparatuses on standby, it is possible to prevent the temperature rise of the communication device by restricting the sending from other transmission apparatuses so as to reduce the amount of data to be processed by the communication device, thereby preventing failures and malfunctions of the communication device.

Moreover, in the embodiment 1, although description has been made on a case in which the transmission apparatus A in FIG. 1 stops the sending of information from the transmission apparatus A-1 to the transmission apparatus A, the embodiments are not be limited to such a case, and may be applicable to any transmission apparatus which transmits data to and from an apparatus (for example, a router, a switch, etc.) connected by a communication interface (for example, 10base2) for performing a half-duplex communication scheme.

Furthermore, in the embodiment 1, although description has been made on a case in which backpressure is successively sent, the embodiments are not be limited to such a case and it is possible to send backpressure intermittently to an extent in which failures and malfunctions of the communication device will not be induced (for example, to receive a fixed amount of data every 10 seconds from another transmission apparatus).

### Embodiment 2

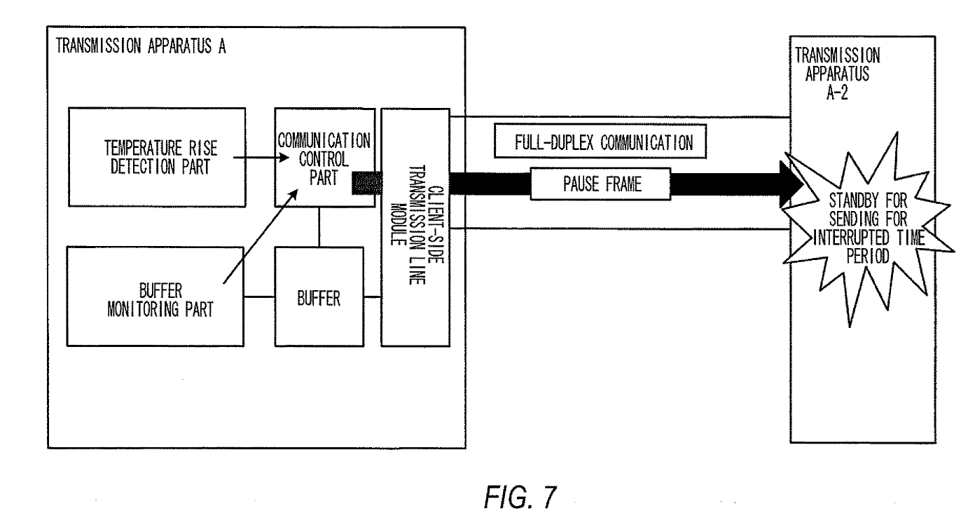

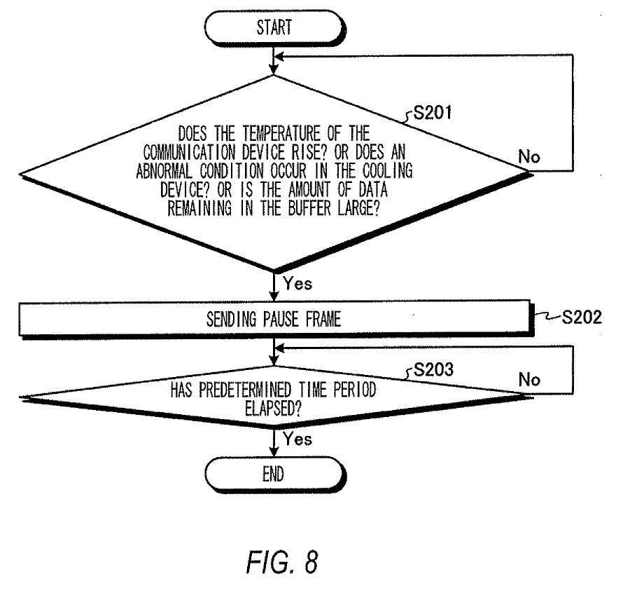

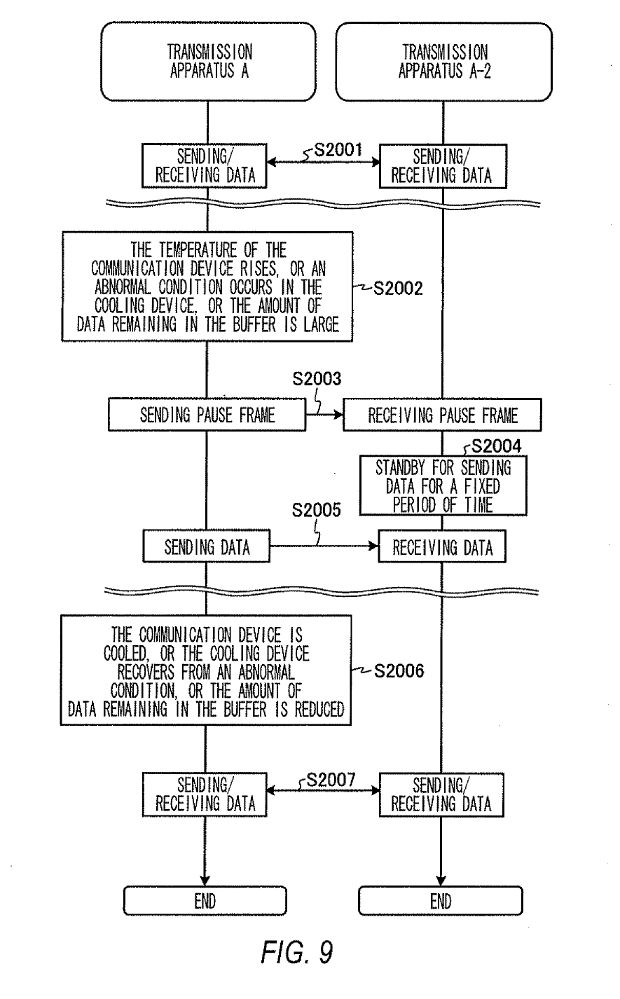

On the other hand, although, in the above described embodiment 1, description has been made on a case in which backpressure is sent to other transmission apparatuses, the embodiments are not limited to such a case, and communication may be controlled, for example, by sending a pause frame, which is a frame for requiring to stop sending data, to other transmission apparatuses. Hereinafter, referring to FIGS. 7 to 9, description will be made on a case, as the embodiment 2, in which communications is controlled by transmitting a pause frame to other transmitting devices. FIG. 7 illustrates the outline and features of the transmission apparatus relating to the embodiment 2, FIG. 8 is a flowchart to show the processing flow by the transmission apparatus relating to the embodiment 2, and FIG. 9 is a sequence to show an example of transmission processing by the transmission apparatus relating to the embodiment 2.

Outline and Features of the Transmission Apparatus Relating to Embodiment 2:

As shown in FIG. 7, the transmission apparatus relating to the embodiment 2 controls communication by transmitting data to and from other transmission apparatuses through a full-duplex communication scheme. Specifically describing by way of example, it is for example a transmission apparatus which is connected to a communication interface (for example, 100base-T) (duplex line) for performing a full-duplex communication scheme as with case of the transmission apparatus A and the transmission apparatus A-2 in FIG. 1, and generally controls the transmission by using a pause frame.

More specifically, the transmission apparatus relating to the embodiment 2 (for example, the transmission apparatus A in FIG. 1) performs transmission with other transmission apparatuses through a full-duplex communication scheme, and when the amount of data remaining in the buffer memory is large, or when a delay occurs in the transfer of data, sends a pause frame, which is a signal for stopping the sending of data from the communication control part to other transmission apparatuses (for example, the transmission apparatus A-2 in FIG. 1) via a client-side transmission line module for a predefined, fixed time period (for example, 3 minutes) such that the data remaining in the buffer memory can be quickly transferred, thereby putting the sending of data from other transmission apparatuses to the concerned transmission apparatus on standby for a fixed time period. Thus, the transmission apparatus relating the embodiment 2 puts the sending of data from other transmission apparatuses (for example, the transmission apparatus A-2) to the concerned transmission apparatus (for example, the transmission apparatus A) on standby.

In the outline describe above, it is a principal feature of the transmission apparatus relating to the embodiment 2 to utilize the above described pause frame to prevent failures and malfunctions of the communication device in the transmission apparatus associated with the temperature rise of the transmission apparatus. Specifically, as shown in FIG. 7, when the temperature rise is detected at the temperature rise detection part, the transmission apparatus relating to the embodiment 2 (for example, the transmission apparatus A in FIG. 1) sends a pause frame, which is a signal for stopping the sending of data for a fixed period of time, from the communication control part via the client-side transmission line module to other transmission apparatuses (for example, the transmission apparatus A-2 in FIG. 1) to put the sending of data from the other transmission apparatus (the transmission apparatus A-1) to the concerned transmission apparatus (the transmission apparatus A) on standby for a predefined, fixed time period (for example, 3 minutes). Consequently, the transmission apparatus relating to the embodiment 2, as with the principal feature described above, can prevent failures and malfunctions of the communication device in the transmission apparatus associated with the temperature rise of the transmission apparatus by using the above described pause frame.

Configuration of Transmission Apparatus Relating to Embodiment 2:

The transmission apparatus relating to the embodiment 2 has a similar structure to that of the transmission apparatus 10 shown in FIG. 4 and operates in a similar fashion except the communication control part 23 described below.

The communication control part 23 performs control so as to restrict the sending from other transmission apparatuses by sending a pause frame to other transmission apparatuses when the temperature rise of the transmission apparatus is detected. Specifically, the communication control part 23 sends a pause frame, which is a signal for stopping a full-duplex communication scheme to other transmission apparatuses, upon receiving a signal for restricting communication, from the temperature rise detection part 21 and the buffer monitoring part 22.

To give a specific example, in the transmission apparatus A in FIG. 1, the communication control part 23 receives a signal for restricting communication from the temperature rise detection part 21 detecting a temperature rise and/or from the buffer monitoring part 22 and sends a pause frame which is a signal for stopping the sending of data for a fixed time period to the transmission apparatus A-2 which is a transmission apparatus connected through a full-duplex communication scheme, thereby stopping the sending of information from the transmission apparatus A-2 to the transmission apparatus A.

Processing by Transmission Apparatus Relating to Embodiment 2:

Next, referring to FIG. 8, the processing by the transmission apparatus relating to the embodiment 2 will be described. FIG. 8 is a flowchart to show the flow of processing by the transmission apparatus relating to the embodiment 2.

As shown in FIG. 8, when the temperature rise of the communication device in the transmission apparatus 10 is detected, when an abnormal condition occurs in the operation of the cooling device, or when the amount of data remaining in the buffer is large (Yes S201), the communication control part 23 sends a pause frame to other transmission apparatuses (S202). That is, upon receiving a signal for restricting communication from the temperature rise detection part 21 and/or the buffer monitoring part 22, the communication control part 23 sends a pause frame, which is a signal for stopping the sending of data for a predefined, fixed time period (for example, 3 minutes), to other transmission apparatuses.

Successively, when a predefined time period (a time period shorter than that specified in a pause frame, for example 2 minutes 50 seconds) has elapsed (Yes S203), the transmission apparatus 10 returns to the detection state again (S201). That is, the transmission apparatus 10 ends the above described processing, and when the temperature rise of the communication device in the transmission apparatus 10 is detected even after the predetermined time period has elapsed, or when an abnormal condition has occurred in the operation of the cooling device, or when the amount of data remaining in the buffer is large, sends a pause frame from the communication control part 23 again within a differential time between the fixed time period and the predetermined time period (in the above described example, between 2 minutes 50 seconds and 3 minutes) thereby causing the sending of data from other transmission apparatuses to continue to be stopped.

Thus, the transmission apparatus 10 causes the sending of data from other transmission apparatuses to be stopped by repeatedly performing the above described processing (S201 to 203) until: when the communication device is cooled in the case in which the temperature of the communication device has risen, when the cooling device is repaired in the case in which the cooling device has been in failure, or when the amount of data remaining in the buffer is reduced in the case in which the amount of data remaining in the buffer has been large, or any combinations thereof.

Example of Transmission Processing by Transmission Apparatus Relating to Embodiment 2:

Next, an example of the transmission processing by the transmission apparatus relating to the embodiment 2 will be described. FIG. 9 is a sequence to show an example of the transmission processing by the transmission apparatus relating to the embodiment 2. Moreover, hereinafter, description will be made on a case as an example, in which the transmission apparatus A, which is a transmission apparatus relating to the embodiment 1, restricts the sending from the transmission apparatus A-2, which are connected by a communication interface for performing a full-duplex communication scheme as with case of the transmission apparatus A and the transmission apparatus A-2 shown in FIG. 1.

As shown in FIG. 9, the transmission apparatus A performs the transmission with the transmission apparatus A-2 through a full-duplex communication scheme. That is, in the transmission apparatus A, when the temperature rise of the communication device has not been detected, when an abnormal condition in the operation of the cooling device has not occurred, and/or when the amount of data remaining in the buffer is small, the transmission apparatus A and the transmission apparatus A-2 simultaneously perform sending/receiving between them (S2001).

Here, in the transmission apparatus A, when a case occurs in which the temperature rise of the communication device is detected, an abnormal conditions occurs in the operation of the cooling device, or the amount of data remaining in the buffer is large (S2002), the communication control part 23 in the transmission apparatus A sends a pause frame to the transmission apparatus A-2 (S2003). Consequently, the transmission apparatus A-2 which has received a pause frame stands by for sending data to the transmission apparatus A for a fixed time period (S2004). On the other hand, the transmission apparatus A sends data to the transmission apparatus A-2 (S2005).

Thereafter, while a fixed time period specified in the pause frame has elapsed, for example, when the communication device is cooled in the case in which the temperature of the communication device has risen, when the cooling device is repaired in the case in which the cooling device has been in failure, and when the amount of data remaining in the buffer is reduced in the case in which the amount of data remaining in the buffer has been large (S2006), the transmission apparatus A and the transmission apparatus A-1 again simultaneously performs sending/receiving (S2007).

### Effect of Embodiment 2

Thus, according to the embodiment 2, since control is performed such that the sending from other transmission apparatuses is restricted by sending a pause frame, which is a signal for stopping the sending of data to other transmission apparatus, so that the transmission from other transmission apparatus to the concerned transmission apparatus is stopped for a fixed time period, it is possible to prevent the temperature rise by restricting the sending from other transmission apparatuses thereby preventing failures and malfunctions of the communication device.

Moreover, although in the embodiment 2, description has been made on a case in which the transmission apparatus A in FIG. 1 stops the sending of information from the transmission apparatus A-2 to the transmission apparatus A, the embodiments are not be limited to such a case and can be applied to any transmission apparatus which transmits data to and from an apparatus (for example, a router, a switch and the like) connected by a communication interface (for example, 100base-T) for performing a full-duplex communication scheme.

Further, although in the embodiment 2, description has been made on a case in which the transmission apparatus returns to the detection state when a predefined time period (a time period less than that specified in a pause frame; for example, 2 minutes 50 seconds) has elapsed, the embodiments are not be limited to such a case and may be configured such that the transmission apparatus returns to the detection state when a time period has elapsed to an extent in which failures and malfunctions of the communication device will not be induced (a time period more than that specified in a pause frame; for example, 3 minutes 10 seconds).

### Embodiment 3

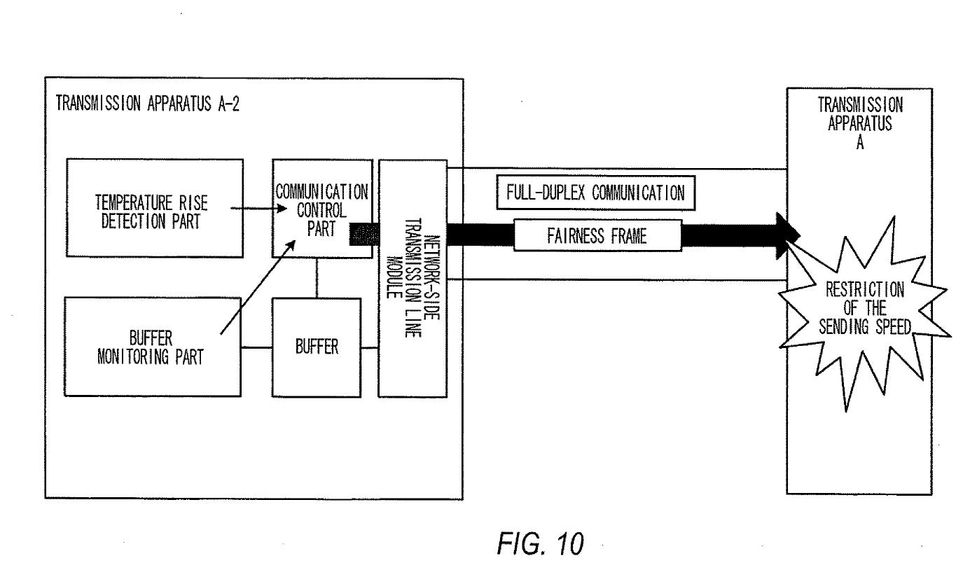

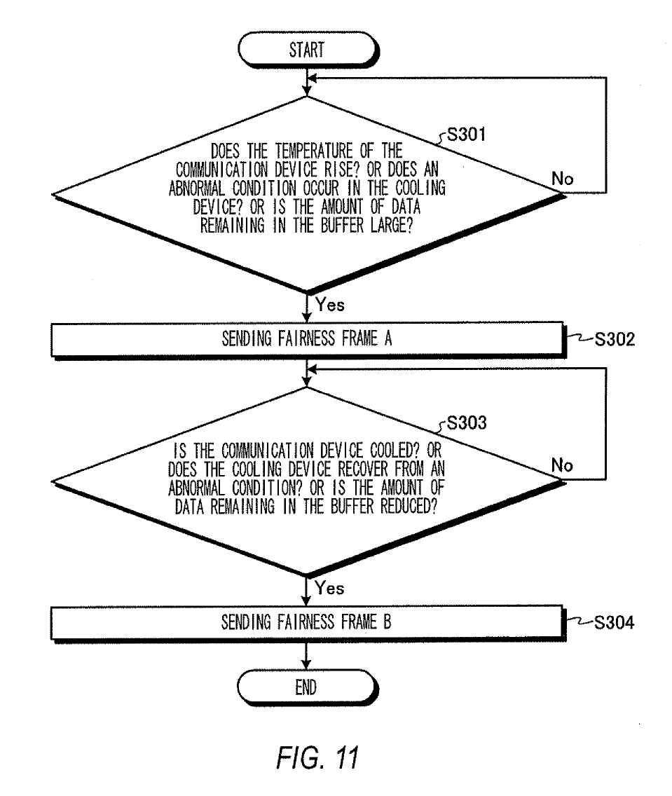

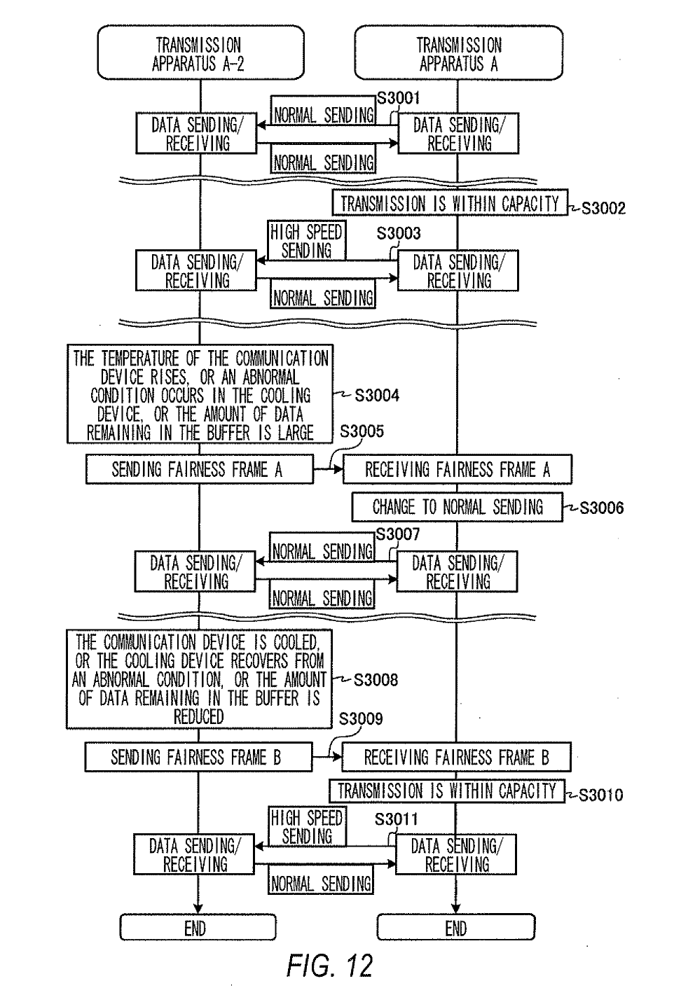

Although, so far description has been made on the cases in which backpressure is sent to other transmission apparatuses in the above described embodiment 1 and a pause frame is sent to other transmission apparatuses in the embodiment 2, the embodiments are not be limited to such cases and, for example, a fairness frame, which is a signal for changing the speed of sending data, may be sent to other apparatuses to control communication. Accordingly, hereinafter, a case in which a fairness frame is sent to other transmission apparatuses to control communication will be described as an embodiment 3 using FIGS. 10, 11, and 12. FIG. 10 illustrates the outline and features of a transmission apparatus relating to the embodiment 3, FIG. 11 is a flowchart to show the processing flow by the transmission apparatus relating to the embodiment 3, and FIG. 12 is a sequence to show an example of transmission processing by the transmission apparatus relating to the embodiment 3.

Outline and Features of Transmission Apparatus Relating to Embodiment 3:

As shown in FIG. 10, the transmission apparatus relating to the embodiment 3 transmits data to and from other transmission apparatuses through a full-duplex communication scheme to control communication Specifically, it is for example a transmission apparatus which is connected by a communication interface (for example, 100base-T) (duplex line) for performing a full-duplex communication scheme as with the case of the transmission apparatus A and the transmission apparatus A-2 in FIG. 1, and generally controls the transmission by using a fairness frame.

More specifically, when communication is congested in a full-duplex communication scheme (for example, sending is performed at 100 Mbps (megabits per second) in the communication through a 100base-T interface which enables communication at a sending speed of 100 Mbps), the transmission apparatus relating to the embodiment 3 (for example, the transmission apparatus A-2 in FIG. 1) performs communication with other transmission apparatuses (for example, the transmission apparatus A in FIG. 1) at a predefined sending speed (for example, 50 Mbps).

In this respect, if marginal space is generated in the communication from another transmission apparatus to the transmission apparatus relating to the embodiment 3 (for example, sending is performed at 50 Mbps in the communication through a 100base-T interface), the another transmission apparatus spontaneously changes the sending speed so as to perform communication with the transmission apparatus relating to the embodiment 3 to as high a communication speed as the communication interface can transmit (for example, 100 Mbps).

On the other hand, when the amount of data remaining in the buffer memory is large, and/or when a delay occurs in the data transfer, the transmission apparatus relating to the embodiment 3 sends a fairness frame A, which is a signal for changing the sending speed to a predefined speed, to another transmission apparatus from the communication control part through a network-side transmission line module so that the data remaining in the buffer memory can be quickly transferred. That is, when another transmission apparatus is sending data to the transmission apparatus relating to the embodiment 3 at a high speed (for example, 100 Mbps) and the amount of data remaining in the buffer memory is large, or when a delay occurs in the data transfer, or any combinations thereof, the transmission apparatus relating to the embodiment 3 changes the sending speed from the another transmission apparatus to the transmission apparatus relating to the embodiment 3 to a predefined sending speed (for example, 50 Mbps). Thus, the transmission apparatus relating to the embodiment 3 restricts the speed of sending data from another transmission apparatus (for example, the transmission apparatus A) to the concerned transmission apparatus (for example, the transmission apparatus A-2).

In the outline described above, it is a principal feature of the transmission apparatus relating to the embodiment 3 to utilize the above described fairness frame to prevent failures and malfunctions of the communication device in the transmission apparatus associated with the temperature rise of the transmission apparatus. Specifically, as shown in FIG. 10, when a temperature rise is detected at the temperature detection part, the transmission apparatus relating to the embodiment 3 (for example, the transmission apparatus A-2 in FIG. 1) sends a fairness frame A to another transmission apparatus (for example, the transmission apparatus A in FIG. 1) from the communication control part through the network-side transmission line module to change the speed of sending data to the concerned transmission apparatus (the transmission apparatus A-2) from the another transmission apparatus (the transmission apparatus A) to a predefined speed (for example, 50 Mbps). Consequently, the transmission apparatus relating to the embodiment 3, as with the above described principal feature, can prevent failures and malfunctions of the communication device in the transmission apparatus associated with the temperature rise of the transmission apparatus by using the above described fairness frame.

Configuration of Transmission Apparatus Relating to Embodiment 3:

The transmission apparatus relating to the embodiment 3 has a similar structure to that of the transmission apparatus 10 shown in FIG. 4 and operates in a similar fashion except the communication control part 23 described below.

The communication control part 23 performs control so as to restrict the sending from another transmission apparatus by sending a fairness frame to the another transmission apparatus when the temperature rise of the transmission apparatus is detected. Specifically, the communication control part 23 sends a fairness frame, which is a signal for changing the speed of sending data, to another transmission apparatus upon receiving a signal for restricting communication from the temperature rise detection part 21 and/or the buffer monitoring part 22.

To give a specific example, in the transmission apparatus A-2, the communication control part 23 receives a signal for restricting communication from the temperature rise detection part 21 detecting a temperature rise and/or from the buffer monitoring part 22 and sends a fairness frame A, which is a signal for changing the speed of sending data to a predefined speed, to the transmission apparatus A which is a transmission apparatus connected through a full-duplex communication scheme, thereby changing the speed of sending data from the transmission apparatus A to the transmission apparatus A-2. Then, when a situation in which the temperature detection part 21 and/or the buffer monitoring part 22 in the transmission apparatus A-2 send a signal for avoiding controlling communication to the communication control part 23 (for example, when the communication device is cooled in the case in which the temperature of the communication device has risen, the cooling device is repaired in the case in which the cooling device has been in failure, or the amount of data remaining in the buffer is reduced in the case in which the amount of data remaining in the buffer has been large, or any combinations thereof), the communication control part 23 sends a fairness frame B, which is the information for permitting the change to a higher sending speed, to the transmission apparatus A.

Processing by Transmission Apparatus Relating to Embodiment 3:

Next, referring to FIG. 11, the processing by the transmission apparatus relating to the embodiment 3 will be described. FIG. 11 is a flowchart to show the flow of processing by the transmission apparatus relating to the embodiment 3.

As shown in FIG. 11, when a temperature rise of the communication device in the transmission apparatus 10 is detected, when an abnormal condition occurs in the operation of the cooling device, or when the amount of data remaining in the buffer is large (Yes S301), the communication control part 23 sends a fairness frame A to another transmission apparatus (S302). That is, upon receiving a signal for restricting communication from the temperature rise detection part 21 and/or the buffer monitoring part 22, the communication control part 23 sends a fairness frame A, which is a signal for changing to a predefined sending speed, to another transmission apparatus.

Successively, when the communication device is cooled, or when the cooling device recovers from an abnormal condition, or when the amount of data remaining in the buffer is reduced, that is, when the communication device is cooled in the case in which the temperature of the communication device has risen, when the cooling device is repaired in the case in which the cooling device has been in failure, or when the amount of data remaining in the buffer is reduced in the case in which the amount of data remaining in the buffer has been large (Yes at S303), the communication control part 23 sends a fairness frame B, which is a signal for permitting the change to a higher sending speed, to another transmission apparatus (S304) and the transmission apparatus 10 ends the above described processing, again returning to the detection state (S301). That is, when a signal for restricting communication from the temperature detection part 21 and/or the buffer monitoring part 22 becomes absent, the communication control part 23 sends a fairness frame B, which is a signal for permitting the change to a higher sending speed, to another transmission apparatus and the transmission apparatus 10 again monitors the temperature rise of the communication device, the operational condition of the cooling device, or the buffer.

Example of Transmission Processing by Transmission Apparatus Relating to Embodiment 3:

Next, referring to FIG. 12, an example of the transmission processing by the transmission apparatus relating to the embodiment 3 will be described. FIG. 12 is a sequence to show an example of the transmission processing by the transmission apparatus relating to the embodiment 3. Hereinafter, description will be made on a case as an example, in which the transmission apparatus A-2, which is a transmission apparatus relating to the embodiment 1, restricts the sending from the transmission apparatus A, which are connected by a communication interface for performing a full-duplex communication scheme as with case of the transmission apparatus A-2 and the transmission apparatus A shown in FIG. 1.

As shown in FIG. 12, the transmission apparatus A-2 performs the transmission with the transmission apparatus A through a full-duplex communication scheme and at a predefined sending speed (S3001). That is, in the transmission apparatus A-2, when the temperature rise of the communication device has not been detected, when an abnormal condition in the operation of the cooling device has not occurred, or when the amount of data remaining in the buffer is small, or any combinations thereof, the transmission apparatus A-2 and the transmission apparatus A perform sending/receiving at a predefined sending speed (for example, 50 Mbps) (NORMAL SENDING in the example of FIG. 12).

In this respect, if marginal space is generated in the communication from the transmission apparatus A to the transmission apparatus A-2 (S3002), the transmission apparatus A spontaneously changes the sending speed to as high a communication speed as the transmission apparatus A-2 and the communication interface can transmit (for example, 100 Mbps) (“HIGH SPEED SENDING” in the example of FIG. 12) and performs transmission (S3003).

On the other hand, when a case occurs in which a temperature rise of the communication device is detected, an abnormal conditions occurs in the operation of the cooling device, or the amount of data remaining in the buffer is large in the transmission apparatus A-2 (S3004), the transmission apparatus A-2 sends a fairness frame A, which is a signal for changing to a predefined sending speed, to the transmission apparatus A (S3005). As the result, the transmission apparatus A changes the speed of sending data to a predefined sending speed (S3006) and performs sending/receiving to and from the transmission apparatus A-2 at the predefined sending speed (S3007).

Thereafter, for example, when the communication device is cooled in the case in which the temperature of the communication device has risen, when the cooling device is repaired in the case in which the cooling device has been in failure, or when the amount of data remaining in the buffer is reduced in the case in which the amount of data remaining in the buffer has been large (S3008), the transmission apparatus A-2 sends a fairness frame B, which is a signal for permitting the change to a higher sending speed, to the transmission apparatus A (S3009). As the result, the transmission apparatus A is enabled to change the sending speed to as high a communication speed as the transmission apparatus A-2 and the communication interface can transmit, and when a marginal space is generated in the communication from the transmission apparatus A to the transmission apparatus A-2 (S 3010), the transmission apparatus A changes the sending speed to as high a communication speed as the transmission apparatus A-2 and the communication interface can transmit (S3011).

### Effects of Embodiment 3

Thus, according to the embodiment 3, since control is performed such that the sending from other transmission apparatuses is restricted by sending a fairness frame, which is a signal for changing the speed of sending data, to other transmission apparatuses, it is possible to prevent the rise of temperature by restricting the sending from other transmission apparatuses as the result of restricting the communication speed from other transmission apparatuses to the concerned transmission apparatus, thereby preventing failures and malfunctions of the communication device.

Moreover, although in the embodiment 3, description has been made on a case in which the transmission apparatus A-2 in FIG. 1 restricts the speed of sending information from the transmission apparatus A to the transmission apparatus A-2, the embodiments are not be limited to such case and can be applied to any transmission apparatus which transmits data to and from an apparatus (for example, a router, a switch and the like) connected by a communication interface (for example, 100base-T) for performing a full-duplex communication scheme.

Further, although in the embodiment 3, description has been made on a case in which the transmission apparatus A in FIG. 1 spontaneously changes the sending speed to as a high speed as the communication interface can transmit, the embodiments are not be limited to such case and may be configured such that the sending speed may be actively changed to as a high speed as the communication interface can transmit by the instruction from the transmission apparatus A-2. That is, the fairness frame B may be the signal for causing another transmission apparatus to change to a higher sending speed.

### Embodiment 4

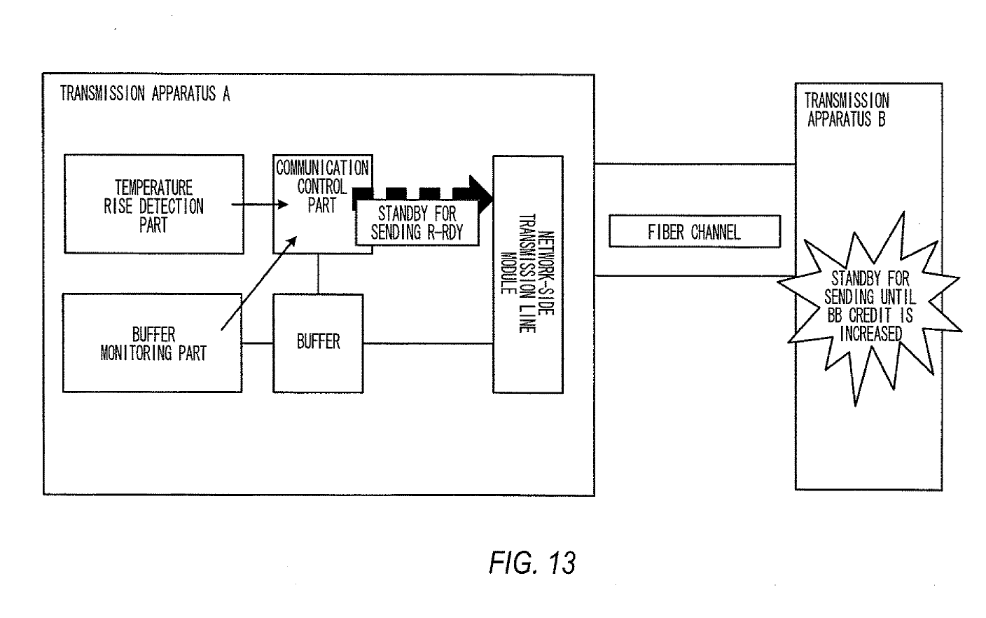

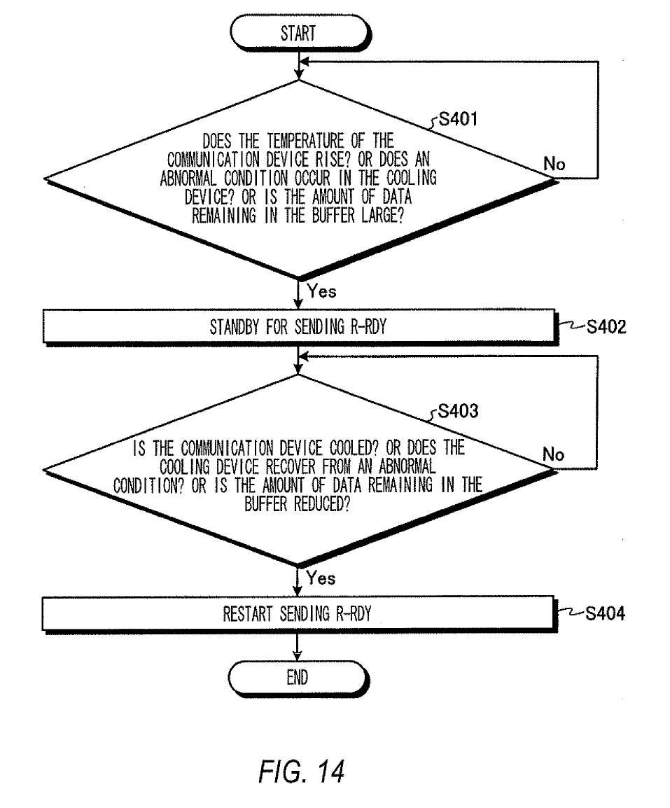

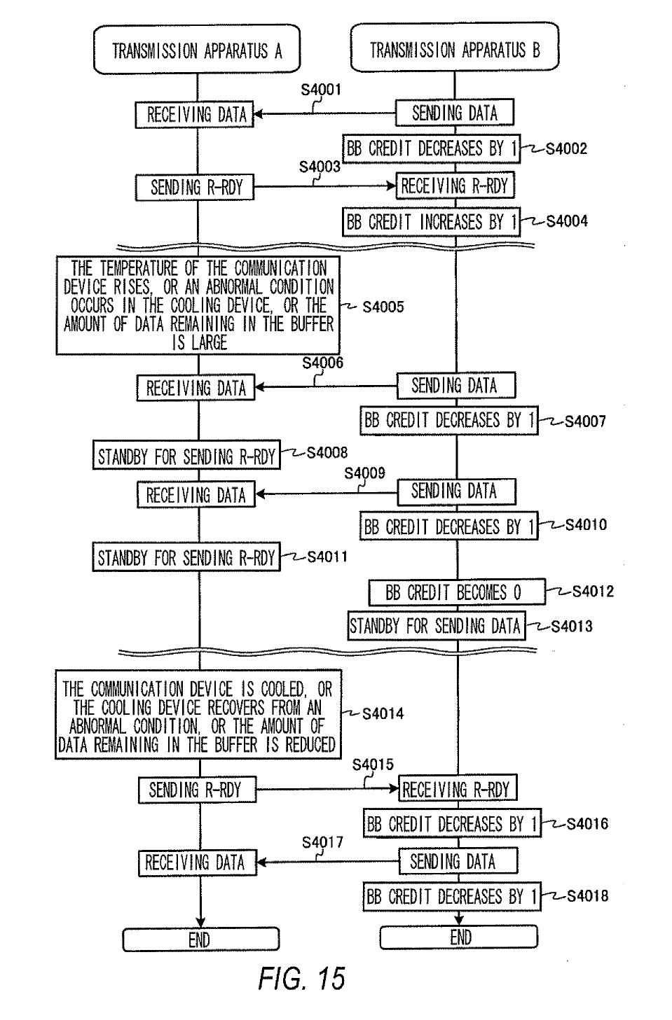

Although, so far description has been made on the cases in which backpressure is sent to other transmission apparatuses in the above described embodiment 1, a pause frame is sent to other transmission apparatuses in the embodiment 2, and a fairness frame is sent to other transmission apparatuses in the embodiment 3, the embodiments are not be limited to such cases and, for example, may be configured such that communication is controlled by standing by for sending R-RDY which is a signal for giving another transmission apparatus the permission to send a fixed amount of data. Accordingly, hereinafter, a case in which communication is controlled by standing by for sending R-RDY will be described as an embodiment 4 using FIGS. 13, 14, and 15. FIG. 13 illustrates the outline and features of a transmission apparatus relating to the embodiment 4, FIG. 14 is a flowchart to show the processing flow by the transmission apparatus relating to the embodiment 4, and FIG. 15 is a sequence to show an example of transmission processing by the transmission apparatus relating to the embodiment 4.

Outline and Features of Transmission Apparatus Relating to Embodiment 4:

As shown in FIG. 13, the transmission apparatus relating to the embodiment 4 transmits data to and from other transmission apparatuses connected by Fiber Channel which is a communication interface for performing a high speed communication to control communication. To give an example for explanation, it is for example a transmission apparatus which is connected by Fiber Channel (for example, optical cable, copper wire, etc.) (thick line) as with the case of the transmission apparatus A and the transmission apparatus B in FIG. 1, and is outlined that the transmission is controlled by standing by for sending R-RDY which is a signal for giving another transmission apparatus the permission to send a fixed amount of data.

More specifically, the transmission apparatus relating to the embodiment 4 (for example, the transmission apparatus A in FIG. 1) performs transmission to and from other transmission apparatuses (for example, the transmission apparatus B in FIG. 1) through Fiber Channel. To give an example for explanation, in FIG. 1, once the transmission apparatus B sends a fixed amount of data to the transmission apparatus A, the transmission apparatus B decrease its BB credit (buffer-to-buffer credit) by 1, which specifies the number of times to be allowed to send a fixed amount of data to the transmission apparatus A. Then, having received the fixed amount of data, the transmission apparatus A sends R-RDY, which is a signal for giving the permission to send a fixed amount of data, to the transmission apparatus B when there is space in the buffer memory, thereby increasing the BB credit of the transmission apparatus B by 1.

On the other hand, when the amount of data remaining in the buffer memory is large or when a delay occurs in the transfer of data, the sending of R-RDY is put on standby at the communication control part so that the data remaining in the buffer memory can be quickly transferred. As the result, the transmission apparatus B sends a fixed amount of data to the transmission apparatus A until the BB credit runs out, that is, the credit number becomes “0” and thereafter stands by for sending data to the transmission apparatus A until the BB credit increases. Thus, the transmission apparatus relating to the embodiment 4 put the sending of data from other transmission apparatuses (for example, the transmission B) to the concerned transmission apparatus (for example, the transmission apparatus A) on standby.

In the outline described above, it is a principal feature of the transmission apparatus relating to the embodiment 4 to utilize the above described R-RDY to prevent failures and malfunctions of the communication device associated with the temperature rise of the transmission apparatus. Specifically, as shown in FIG. 13, upon detecting the temperature rise at the temperature rise detection part, the transmission apparatus relating to the embodiment 4 (for example, the transmission apparatus A) puts the sending of data from the another transmission apparatus (transmission apparatus B) to the concerned transmission apparatus (transmission apparatus A) on standby by standing by for sending R-RDY from the communication control part to another transmission apparatus thereby causing the BB credit of the another transmission apparatus to run out. As the result, the transmission apparatus relating to the embodiment 4, as with the above described principal feature, can utilize the above described R-RDY to prevent failures and malfunctions of the communication device in the transmission apparatus associated with the temperature rise of the transmission apparatus.

Configuration of Transmission Apparatus Relating to Embodiment 4:

The transmission apparatus relating to the embodiment 4 has a similar structure to that of the transmission apparatus 10 shown in FIG. 4 and operates in a similar fashion except the communication control part 23 described below.

The communication control part 23 performs control so as to restrict the sending from other transmission apparatuses by standing by for sending R-RDY when the temperature rise of the transmission apparatus is detected. Specifically, upon receiving a signal for restricting communication from the temperature rise detection part 21 and/or from the buffer monitoring part 22, the communication control part 23 stands by for sending R-RDY, which is a signal for giving another transmission apparatus the permission to send a fixed amount of data.

To give a specific example, in the transmission apparatus A in FIG. 1, the communication control part 23 receives a signal for restricting communication from the temperature rise detection part 21 detecting a temperature rise and/or from the buffer monitoring part 22 and stands by for sending R-RDY. Then, when a situation in which the temperature detection part 21 and/or the buffer monitoring part 22 send a signal for avoiding controlling communication to the communication control part 23 (for example, when the communication device is cooled in the case in which the temperature of the communication device has risen, the cooling device is repaired in the case in which the cooling device has been in failure, or the amount of data remaining in the buffer is reduced in the case in which the amount of data remaining in the buffer has been large), the sending of R-RDY to the transmission apparatus B is restarted.

Processing by Transmission Apparatus Relating to Embodiment 4:

Next, referring to FIG. 14, the processing by the transmission apparatus relating to the embodiment 4 will be described. FIG. 14 is a flowchart to show the flow of processing by the transmission apparatus relating to the embodiment 4.

As shown in FIG. 14, when the temperature rise of the communication device in the transmission apparatus 10 is detected, when an abnormal condition occurs in the operation of the cooling device, or when the amount of data remaining in the buffer is large (Yes S401), the communication control part 23 stands by for sending R-RDY to other transmission apparatuses (S402). That is, upon receiving a signal for restricting communication from the temperature rise detection part 21 and the buffer monitoring part 22, the communication control part 23 stands by for sending R-RDY to other transmission apparatuses.

Successively, when the communication device is cooled, or when the cooling device recovers from an abnormal condition, or when the amount of data remaining in the buffer is reduced, that is, when the communication device is cooled in the case in which the temperature of the communication device has risen, when the cooling device is repaired in the case in which the cooling device has been in failure, or when the amount of data remaining in the buffer is reduced in the case in which the amount of data remaining in the buffer has been large (Yes at S403), the communication control part 23 restarts sending R-RDY to other transmission apparatuses (S 404) and the transmission apparatus 10 again returns to the detection state S401). That is, when a signal for restricting communication from the temperature detection part 21 and the buffer monitoring part 22 becomes absent, the communication control part 23 restarts sending R-RDY to other communication apparatuses and the transmission apparatus 10 ends the above described processing and again monitors the temperature rise of the communication device, the operational condition of the cooling device, or the buffer.

Example of Transmission Processing by Transmission Apparatus Relating to Embodiment 4:

Next, referring to FIG. 15, an example of the transmission processing by the transmission apparatus relating to the embodiment 4 will be described. FIG. 15 is a sequence to show an example of the transmission processing by the transmission apparatus relating to the embodiment 4. Moreover, hereinafter, description will be made on a case as an example, in which the transmission apparatus A, which is a transmission apparatus relating to the embodiment 1, restricts the sending from the transmission apparatus B, which are connected by Fiber Channel as with case of the transmission apparatus A and the transmission apparatus B shown in FIG. 1.

As shown in FIG. 15, the transmission apparatus A performs the transmission with the transmission apparatus B through Fiber Channel. That is, once a fixed amount of data is sent from the transmission apparatus B to the transmission apparatus A when the temperature rise of the communication device has not been detected, an abnormal condition in the operation of the cooling device has not occurred, and/or the amount of data remaining in the buffer is small in the transmission apparatus A (S4001), the transmission apparatus B decreases its BB credit by 1 (S4002). As the result, having received the fixed amount of data, the transmission apparatus A sends R-RDY to the transmission apparatus B when there is space in the buffer memory (S4003), thereby increasing the BB credit of the transmission apparatus B by 1 (S4004).

At this moment, when a case occurs in which the temperature rise of the communication device is detected, or an abnormal condition occurs in the operation of the cooling device, or the amount of data remaining in the buffer is large, in the transmission apparatus A (S4005), the transmission apparatus B sends a fixed amount of data to the transmission apparatus A (S4006), and when the BB credit is decreased by 1 (S4007), the transmission apparatus A stands by for sending R-RDY to the transmission apparatus B (S4008). As the result of repeating the above described processing (S4009 to S4011), the transmission apparatus B runs out of BB credit, that is, the credit number becomes “0” (S4012) and it stands by for sending data to the transmission apparatus A (S4013).

Thereafter, for example, when the communication device is cooled in the case in which the temperature of the communication device has risen, when the cooling device is repaired in the case in which the cooling device has been in failure, or when the amount of data remaining in the buffer is reduced in the case in which the amount of data remaining in the buffer has been large (S4014), the communication control part 23 of the transmission apparatus A restarts sending R-RDY to the transmission apparatus B (S4015), thereby increasing the BB credit of the transmission apparatus B by 1 (S4016). As the result, the transmission apparatus B sends a fixed amount of data to the transmission apparatus A (S4017) thereby reducing its BB credit by 1 (S4018). That is, the transmission apparatus A and the transmission apparatus B again perform transmission through Fiber Channel (S4015 to S4018).

### Effects of Embodiment 4

Thus, according to the embodiment 4, since control is performed such that the sending from other transmission apparatuses is restricted by standing by for sending R-RDY, which is a signal for giving other transmission apparatuses the permission to send a fixed amount of data, it is possible to prevent the rise of temperature by restricting the sending from other transmission apparatuses as the result of putting the sending of R-RDY of the transmission apparatus on standby and causing the BB credit of other transmission apparatuses to run out thereby stopping the sending, thus preventing failures and malfunctions of the communication device.

Moreover, although in the embodiment 4, description has been made on a case in which the transmission apparatus A in FIG. 1 restricts the sending of information from the transmission apparatus B to the transmission apparatus A, the embodiments are not be limited to such case and can be applied as well to any transmission apparatus which transmits data to and from an apparatus (for example, a router, a switch and the like) which controls the sending of data using R-RDY and BB credit.

### Embodiment 5

So far, though description has bee made on some specific embodiments, the embodiments may be implemented in various different forms other than the aforementioned embodiments. Accordingly, hereinafter another embodiment will be described as an embodiment 5.

For example, although in the embodiments 1 to 4, description has been made on the case in which the temperature of the communication device is measured to restrict the sending from other transmission apparatuses, the embodiments are not be limited to such case and the temperature of the communication device may be estimated to restrict the sending from other transmission apparatuses. For example, the sending from other transmission apparatuses may be restricted by estimating the temperature of the communication device from the electric current therein, or by predicting an incidence when the temperature of the communication device is likely to rise to a predetermined temperature (for example, when the temperature rises from 35 to 45 degrees C. during 10 minute operation).

Moreover, although in the embodiments 1 to 4, description has been made on the case in which the temperature of the transmission apparatus and the operational condition of the cooling device are monitored to restrict the sending from other transmission apparatuses, the embodiments are not be limited to such case, and control may be performed such that the amount of data sent from other transmission apparatuses is variably restricted by monitoring only the temperature of the transmission apparatus or only the operational condition of the cooling device.

Furthermore, in the embodiments 1 to 4, the sending from another transmission apparatus may be variably restricted depending on the rise of the temperature or the estimated temperature of the transmission apparatus and/or the operational condition of the cooling device (for example, may be overly restricted when the temperature of the communication device is 50 degrees C. and slightly restricted when the temperature of the communication device is 40 degrees C.) to reduce the amount of data to be processed by the communication device so that the temperature rise of the communication device is prevented thereby preventing failures and malfunctions of the communication device.

System Configuration and Others:

Any combinations of the described embodiment functions/processes/features may be provided. Further, the processing procedures, control procedures, specific names, information including various data and parameters described herein and shown in the drawings may be arbitrarily changed unless otherwise stated.

Furthermore, each component of illustrated apparatuses represents a functional concept and does not necessarily need to be physically configured as shown in the drawings. That is, specific forms of the distribution and integration of each apparatus are not limited to those shown in the drawings and all or part of them may be distributed or integrated functionally or physically in any unit depending on various loads and use conditions (for example, in FIG. 4, the buffer monitoring part may be integrated into the temperature detection part). Further, all or any part of each processing function performed at each apparatus may be implemented by a CPU and a program analyzed and executed by the CPU, or implemented as hardware by wired logic. In other words, the embodiments can be implemented in computing hardware and/or software.

Transmission Program:

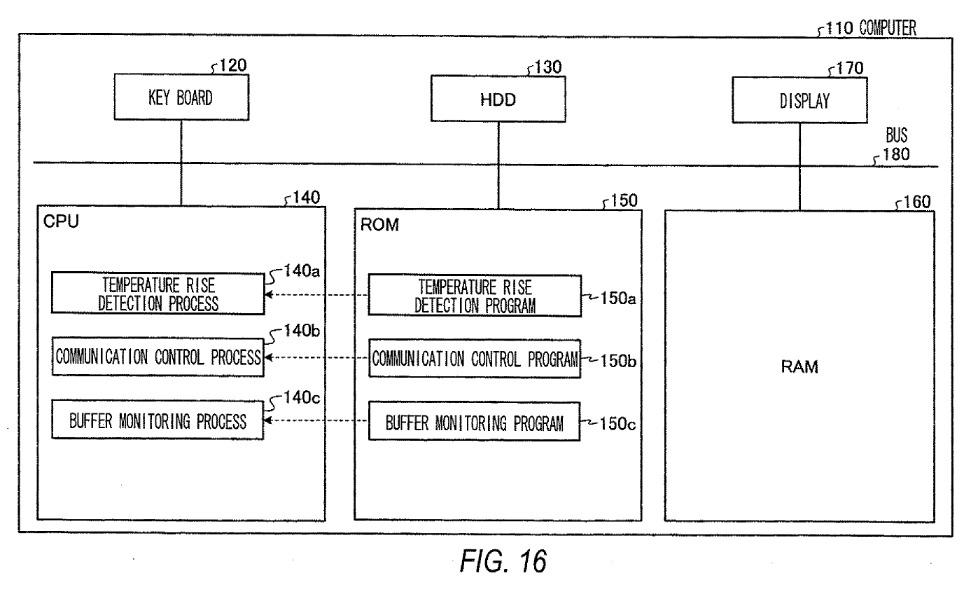

In addition, although in the above described embodiments, description has been made on the case in which various processing is implemented by hardware logic, the embodiments are not limited to such case and may be implemented by executing a preinstalled program by a computer. Then, hereinafter, referring to FIG. 16, description will be made on an example of the computer which executes a transmission program having similar functions as those shown in the above described embodiments. FIG. 16 shows a computer which executes a transmission program.

As shown in the figure, a computer 110 as a transmission apparatus connects a key board 120, a HDD 130, a CPU 140, a ROM 150, a RAM 160 and a display 170 with a bus 180. In the ROM 150, transmission programs which exhibit similar functions to those of the transmission apparatus 10 shown in the above described embodiment 1, that is, a temperature rise detection program 150a, a communication control program 150b, and a buffer monitoring program 150c are stored in advance. Moreover, these programs 150a to 150c may be appropriately integrated or distributed as with each component of the transmission apparatus shown in FIG. 4.

The CPU 140 reads out those programs 150a to 150c from the ROM 150 and executes them so that the programs 150a to 150c function as the temperature rise detection process 140a, the communication control process 140b, and the buffer monitoring process 140c as shown in FIG. 16. Moreover, the processes 140a to 140c respectively correspond to the temperature rise detection part 21, the communication control part 23, and the buffer monitoring part 22 shown in FIG. 4.

Further, the above described programs 150a to 150c does not necessarily need to be stored in the ROM 150 from the beginning and, for example, each program may be stored in any computer readable recording and/or communication medium, such as a “portable physical medium” such as a flexible disk (FD), a CD-ROM, a DVD disk, an optical disk, and an IC card to be inserted into the computer 110, a “stationary physical medium” such as a HDD equipped inside or outside the computer 110, or “another computer (or server)” connected to the computer 110 via a public communication line, the Internet, a LAN, a WAN, etc. so that the computer 110 reads and executes each of those programs.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A transmission apparatus transceiving data to and from another transmission apparatus, comprising:
a temperature rise detector detecting a temperature rise of said transmission apparatus;
a communication controller restricting transmission from said another transmission apparatus when a temperature rise of said transmission apparatus is detected by said temperature rise detection part.

2. The transmission apparatus according to claim 1, wherein said temperature rise detector detects said temperature rise by measuring and/or estimating the temperature of said transmission apparatus.

3. The transmission apparatus according to claim 1, wherein said temperature rise detector detects said temperature rise by monitoring an operational condition of a cooling device cooling said transmission apparatus.

4. The transmission apparatus according to claim 1, wherein said communication controller restricts the transmission from said another transmission apparatus by sending a backpressure signal to said another transmission apparatus.

5. The transmission apparatus according to claim 1, wherein said communication controller restricts the transmission from said another transmission apparatus by sending a pause frame to said another transmission apparatus, said pause frame being information for stopping the transmission of data.

6. The transmission apparatus according to claim 1, wherein said communication controller restricts the transmission from the another transmission apparatus by sending a fairness frame to said another transmission apparatus, said fairness frame being information for changing speed of data transmission.

7. The transmission apparatus according to claim 1, wherein said communication controller restricts the transmission from the another transmission apparatus by standing by for sending R-RDY, said R-RDY being information for giving said another transmission apparatus permission to send a fixed amount of data.

8. The transmission apparatus according to claim 1, wherein said communication controller variably restricts an amount of data to be transmitted from said another transmission apparatus depending on the temperature of said transmission apparatus and/or the operational condition of said cooling device.

9. A transmission method in a transmission apparatus transmitting and/or receiving data to and from another transmission apparatus, comprising:
detecting a temperature rise of said transmission apparatus; and
restricting transmission from said another transmission apparatus when a temperature rise of said transmission apparatus is detected according to the detecting of the temperature.

10. A computer readable recording medium storing a transmission program causing a computer, as a transmission apparatus transmitting and/or receiving data to and from another transmission apparatus, execute operations comprising:
detecting a temperature rise of said transmission apparatus; and
restricting transmission from said another transmission apparatus program when a temperature rise of said transmission apparatus is detected according to the detecting of the temperature.

11. The apparatus according to claim 1, wherein the detecting of the temperature rise of said transmission apparatus comprises measuring and/or estimating a temperature of one or more components including a memory and/or a processor of the transmission apparatus, inside the transmission apparatus, outside the transmission apparatus, or any combinations thereof.

12. The apparatus according to claim 1, further comprising a buffer memory, and wherein the communication controller restricts the transmission from the another transmission apparatus based upon the temperature rise of said transmission apparatus and/or a remaining capacity of the buffer memory.
